(19) United States
(12) Patent Application Publication
(10) Pub. No.: US 2015/0350994 A1
(43) Pub. Date: Dec. 3, 2015

(54) MONITORING NEIGHBOR CELLS IN AN OFFLINE IDLE MODE

(71) Applicant: QUALCOMM Incorporated, San Diego, CA (US)

(72) Inventors: Bhaskara Viswanadham BATCHU, Hyderabad (IN); Priyangshu GHOSH, Hyderabad (IN); Stanley Suyi TSAI, Frederick, CO (US)

(21) Appl. No.: 14/485,239

(22) Filed: Sep. 12, 2014

Related U.S. Application Data
(60) Provisional application No. 62/003,848, filed on May 28, 2014.

(51) Int. Cl. H04W 36/30; H04W 24/08; H04W 36/00

(52) U.S. Cl. CPC H04W 36/30; H04W 36/0094; H04W 24/08

(57) ABSTRACT

The disclosure provides for monitoring neighbor cells while in an offline idle mode. A wireless device monitors cells during a periodic monitoring cycle while in the offline idle mode. In particular, the wireless device monitors the cells by classifying each cell of a list of neighbor cells as one of a first type of neighbor cell having valid overhead information stored in a cache and a second type of neighbor cell that is not associated with valid overhead information stored in the cache. The wireless device selects a monitoring set including an active cell and a subset of the neighbor cells including a cell of the second type of neighbor cell. The wireless device performs a pilot search of the monitoring set, during a periodic monitoring cycle while in a first idle mode state, to determine a signal strength of each cell in the monitoring set for a cell change.

This application claims priority from U.S. Provisional Application No. 62/003,848 entitled “METHODS AND APPARATUS FOR SEARCHING NEIGHBOR CELLS IN AN OFFLINE IDLE MODE,” filed on May 28, 2014, which is incorporated herein by reference in its entirety.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

When a wireless device is not engaged in an active call, the wireless device may enter an idle mode. In an idle mode, the wireless device may reduce the amount of time spent monitoring for signals in order to reduce power consumption. In some cases, such as high mobility circumstances, a wireless device may not detect a strongest cell and may remain camped on a weaker cell. The mobile device may fail to detect an incoming mobile terminated call or may go out of service when it leaves the service area of a current weak cell.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The disclosure provides for monitoring neighbor cells. A wireless device monitors cells during a periodic monitoring cycle while in the offline idle mode. In particular, the wireless device monitors the cells by classifying each cell of a list of neighbor cells as one of a first type of neighbor cell associated with valid overhead information stored in a cache and a second type of neighbor cell that is not associated with valid overhead information stored in the cache. The wireless device selects a monitoring set including an active cell and a subset of the neighbor cells in the list, the subset including a cell of the second type of neighbor cell. The wireless device performs a pilot search of the monitoring set, during a periodic monitoring cycle while in a first idle mode state, to determine a signal strength of each cell in the monitoring set for a cell change.

In an aspect, the disclosure provides a method of wireless communications for monitoring wireless cells. The method may include: classifying each cell of a list of neighbor cells as one of a first type of neighbor cell associated with valid overhead information stored in a cache and a second type of neighbor cell that is not associated with valid overhead information stored in the cache; selecting a monitoring set including an active cell and a subset of the neighbor cells in the list, the subset including a cell of the second type of neighbor cell; and performing a pilot search of the monitoring set, during a periodic monitoring cycle while in a first idle mode state, to determine a signal strength of each cell in the monitoring set for a cell change.

In another aspect, the disclosure provides an apparatus for monitoring wireless cells. The apparatus may include: a cell cache configured to store overhead information associated with neighbor cells; a neighbor cell classifier configured to classify each cell of a list of neighbor cells as one of a first type of neighbor cell associated with valid overhead information stored in the cache and a second type of neighbor cell that is not associated with valid overhead information stored in the cache; a monitoring set selecting component configured to select a monitoring set including an active cell and a subset of the neighbor cells in the list, the subset including a cell of the second type of neighbor cell; and a receiver configured to perform a pilot search of the monitoring set, during a periodic monitoring cycle while in a first idle mode state, to determine a signal strength of each cell in the monitoring set for a cell change.

Another aspect of the disclosure provides another apparatus for monitoring wireless cells. The apparatus may include: means for classifying each cell of a list of neighbor cells as one of a first type of neighbor cell associated with valid overhead information stored in a cache and a second type of neighbor cell that is not associated with valid overhead information stored in the cache; means for selecting a monitoring set including an active cell and a subset of the neighbor cells in the list, the subset including a cell of the second type of neighbor cell; and means for performing a pilot search of the monitoring set, during a periodic monitoring cycle while in a first idle mode state, to determine a signal strength of each cell in the monitoring set for a cell change.

In another aspect, the disclosure provides a computer-readable medium storing computer executable code for monitoring wireless cells. The computer-readable medium may include code for: classifying each cell of a list of neighbor cells as one of a first type of neighbor cell associated with valid overhead information stored in a cache and a second type of neighbor cell that is not associated with valid overhead information stored in the cache; selecting a monitoring set including an active cell and a subset of the neighbor cells in the list, the subset including a cell of the second type of neighbor cell; and performing a pilot search of the monitoring set, during a periodic monitoring cycle while in a first idle mode state, to determine a signal strength of each cell in the monitoring set for a cell change.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

FIG. 1 is a diagram illustrating a wireless device in communication with a radio network.

FIG. 2 is a flowchart illustrating an example of a method of monitoring cells in a neighbor list during an idle mode.

FIG. 3 is a state diagram illustrating classification of neighbor cells.

FIG. 4 is a timing diagram illustrating a scenario for monitoring neighbor cells.

FIG. 5 is a diagram illustrating an example of a hardware implementation for an apparatus employing a processing system.

FIG. 6 is a block diagram illustrating an example of a telecommunications system.

FIG. 7 is a diagram illustrating an example of an access network.

FIG. 8 is a block diagram illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

While in idle mode, a wireless device may limit monitoring of cells in order to conserve power. For example, a wireless device may receive, from an active cell, a neighbor list identifying a plurality of neighbor cells that may be eligible for a cell change procedure such as a handover or reselection. The wireless device may be configured to restrict or limit the number of neighbor cells to be monitored in order to conserve power. For example, the wireless device may monitor only cells for which valid overhead information is stored. These cells, which may be referred to as cheap neighbors or cheap neighbor cells, are described as such because the wireless device may be able to change to such cells without incurring the costs (e.g., processing, power, and/or time costs) of obtaining the overhead information. If, however, the wireless device severely restricts or limits the number of monitored cells, the wireless device may miss an opportunity to change to a stronger neighbor cell without valid cached data. An expensive neighbor or expensive neighbor cell may be a cell for which the wireless device may be able to change to, but because the overhead information is missing or invalid, the wireless device may incur significant costs (e.g., overhead collection, processing, power, and/or time costs) to obtain the cell's overhead information. For example, a receiver of the wireless device may be kept on and consume power for overhead collection. Remaining attached to a weaker cell may result in missed mobile terminated signaling and/or loss of the network.

The present disclosure provides for monitoring of cells on the neighbor list in a manner that balances the costs of monitoring cells and obtaining overhead information with the risk of missing mobile terminated opportunities and loss of the network. During an idle mode in which the wireless device periodically measures available cells, the wireless device may select a monitoring set that includes both cheap neighbor cells and expensive neighbor cells. When an expensive neighbor is the best neighbor, the wireless device may change to an online mode and change to the expensive neighbor cell.

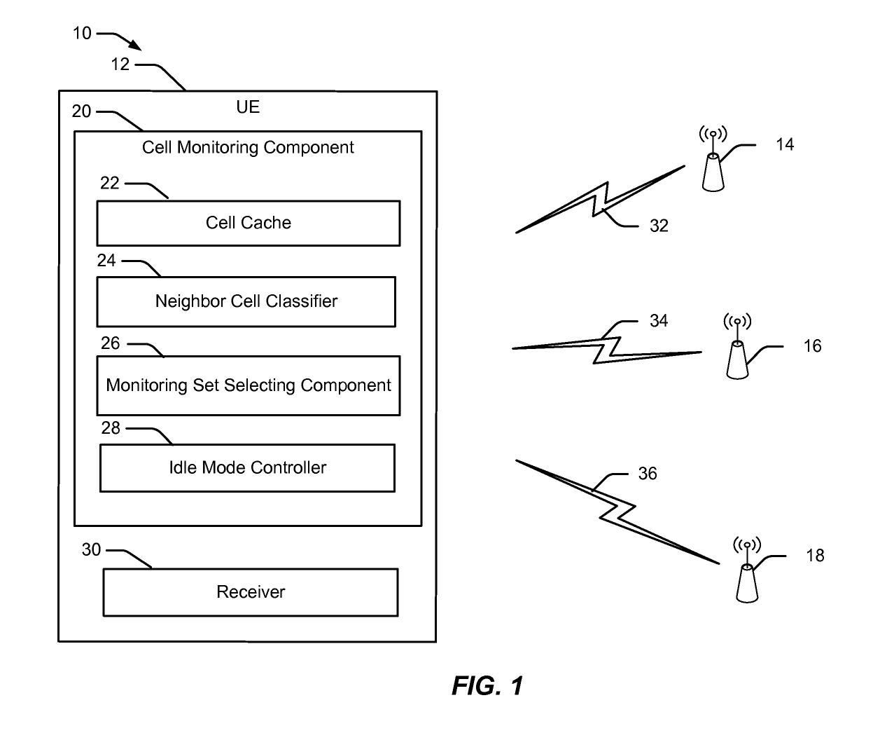

Referring to FIG. 1, in an aspect, a wireless communication system 10 includes a user equipment (UE) 12 having a cell monitoring component 20 configured to monitor neighbor cells while in idle mode. In an aspect, the term “component” as used herein may be one of the parts that make up a system, may be hardware or software, and may be divided into other components. For example, cell monitoring component 20 may include a processor configured to perform a power scan for a set of base stations such as such as base stations 14, 16, or 18. The UE 12 may also include a receiver 30 configured to receive radio signals. The base stations 14, 16, and 18 may each transmit pilot signals 32, 34, 36, respectively. For example, in a WCDMA system, the pilot signals 32, 34, 36 may be identified by pseudo-random noise (PN) sequences or a primary scrambling code (PSC). Other cell identifiers may be used to identify the members of a neighbor cell list for monitoring.

The cell monitoring component 20 may further include a cell cache 22, a neighbor cell classifier 24, a monitoring set selecting component 26, and an idle mode controller 28.

The cell cache 22 may be a storage device or storage medium (e.g., computer-readable medium) configured to store information regarding recently used cells. The cell cache 22 may store an identifier of a cell such as a PN, PSC, or a cell ID. The cell cache 22 may also store overhead information for the cell, which may include any information broadcast by the cell. For example, overhead information may include, but need not be limited to: system information, non-access stratum information, cell selection, reselection, and handover criteria, physical channel information, power control information, measurement control information, and neighbor cell lists. The cell cache 22 may store, for each cell, an indication of whether the stored information is valid. For example, the stored information may be valid for a limited time. The cell cache 22 may store a timestamp indication when the stored information was last updated. Based on both the timestamp indication and on the limited time for which information can be valid, it may be possible to determine whether the stored information in the cell cache 22 for a particular cell is valid or invalid. Invalid overhead information may occur even when a portion of the overhead information has not been updated before the expiration of the limited time for which such information is valid. The information stored in the cell cache 22 may be used to reduce the costs of a cell change because a UE may attach to a cell for which information is stored (e.g., valid overhead information) without having to incur the costs associated with obtaining the overhead information via a broadcast channel. In an aspect, the cell cache 22 may also include a most recent measurement of the received signal strength of the cell from which it may be possible to determine how good of a candidate the cell is for handover or reselection operations.

The neighbor cell classifier 24 may include hardware, firmware, and/or a processor executing software configured to classify the members of a neighbor list based on a cache status. The neighbor list may be transmitted by a current active cell and received by a receiver of the UE (e.g., receiver 30 described in more detail below). In an aspect, a neighbor list may be determined based on a frequency scan. The neighbor cell classifier 24 may classify each neighbor cell based on the status of the neighbor cell in the cell cache 22. A first classification may be a “cheap neighbor cell.” The term “cheap neighbor cell” may indicate a neighbor cell for which the cell cache 22 includes valid overhead information. These cells may be considered cheap in the context of a cell change because the UE 12 may be able to change to such cells without incurring the costs (e.g., processing, power, signaling, and/or time costs) of obtaining the overhead information from the cell. A second classification may be an “expensive neighbor cell.” The term “expensive neighbor cell” may indicate a neighbor cell for which the cell cache 22 does not include valid overhead information. These cells may be considered expensive in the context of a cell change because the UE 12 may not be able to change to such cells without incurring the costs (e.g., processing, power, signaling, and/or time costs) of obtaining the overhead information from the cell. Reception of updated overhead information may be required for a serving cell change to an expensive neighbor cell. For example, the UE 12 may need to power the receiver 30 for a longer time period in order to read the overhead information from a broadcast channel of the expensive neighbor cell. The neighbor cell classifier 24 may further classify an expensive neighbor cell as an “old neighbor cell.” The term “old neighbor cell” may indicate a neighbor cell for which overhead information is stored, but a timestamp indicates that the stored information is no longer valid. The term “new neighbor cell” may indicate a neighbor cell which has been provided in a neighbor cell list and for which the UE has not yet obtained overhead information. The neighbor cell classifier 24 may further classify neighbor cells as “strong.” The term “strong neighbor cell” may indicate that a received signal strength of the cell is greater than a threshold or exceeds a threshold. The term “weak neighbor cell” may indicate that a received signal strength of the cell is less than a threshold. A cheap neighbor cell or an expensive neighbor cell may be further classified as strong or weak. In an aspect, the neighbor cell classifier 24 may generate different sets or lists of neighbor cells. For example, the neighbor cell classifier 24 may generate a list of cheap neighbor cells, old neighbor cells, and expensive neighbor cells. The neighbor cell classifier 24 may further sort the lists according to a received signal strength of each cell such that the strong cells are identified. The lists may be sorted in order of decreasing signal strength. In an aspect, a cell may have layered classifications. For example, a cell may be both cheap and strong (a good candidate for cell change) while another cell may be expensive and weak (not a good candidate for cell change). As another example, a cell may be both expensive and old. A cell with layered classifications may appear on a list for both classifications. Alternatively, a cell may be listed according to the most specific classification. For example, a cell may be an expensive neighbor cell, an old neighbor cell, and a strong neighbor cell, but may be listed as an old neighbor cell as the most specific classification.

The monitoring set selecting component 26 may include hardware, firmware, and/or a processor executing software configured to select a monitoring set. The monitoring set may include a subset of a neighbor cell list to be monitored while the UE 12 is operating in an idle mode. The size of the monitoring set may be less than the size of the list of neighbor cells. In an aspect, for example, the monitoring set may be limited to a total of five cells including the active serving cell. The monitoring set may, however, include more or fewer cells, and the size of the monitoring set may vary. By limiting the size of the monitoring set, the UE 12 may conserve power by monitoring only enough cells to maintain minimal connectivity with the network.

In an aspect, the monitoring set selecting component 26 may be configured to select a set of cells to monitor based on a state of the neighbor cell list. For example, the state of the neighbor cell list may depend on the relative size of the lists generated by the neighbor cell classifier 24. For example, the monitoring set selecting component 26 may place importance on the classification comprising the largest portion of the neighbor cell list. The monitoring set selecting component 26 may also consider the relative signal strengths of the active cell and the cells on the neighbor cell list when determining the state of the neighbor cell list. In an aspect, the state of the neighbor cell list may change in a rotating manner. For example, the monitoring set selecting component 26 may select the monitoring set based upon the current state, and then change the state of the neighbor cell list to the next state. The neighbor cell list may cycle through the available states by changing each periodic monitoring cycle such that different sets of cells are selected for the monitoring set.

In a first monitoring state, the monitoring set selecting component 26 may place particular importance on including cheap neighbor cells as part of the monitoring set. This may be reflected by having a set or fixed minimum number of cheap neighbor cells as part of the monitoring set whenever possible. The monitoring set selecting component 26 may include the active serving cell as well as any cheap neighbor cells. If the active serving cell and the cheap neighbor cells do not fill the monitoring set, the monitoring set selecting component 26 may also select old or strong expensive neighbor cells to fill the monitoring set. In an aspect, the monitoring set selecting component may select one expensive neighbor cell (either an old neighbor cell or strong expensive neighbor cell) and a maximum number of cheap neighbor cells.

In a second monitoring state, the monitoring set selecting component 26 may place importance on strong neighbor cells as part of the monitoring set. This may be reflected by further limiting the number of cheap neighbor cells and including expensive neighbor cells as part of the monitoring set whenever possible. The monitoring set selecting component 26 may limit the number of cheap neighbor cells, for example, to one or two cheap neighbor cells. The monitoring set selecting component 26 may then select the one or two strongest cheap neighbor cells. The monitoring set selecting component 26 may then fill the monitoring set with strong expensive neighbor cells if available. If there are not enough strong expensive neighbor cells to fill the monitoring set, the monitoring set selecting component 26 may select old neighbor cells.

In a third monitoring state, the monitoring set selecting component 26 may place importance on including old neighbor cells in the monitoring set. This may be reflected by further limiting the number of cheap neighbor cells and including old neighbor cells as part of the monitoring set whenever possible. The monitoring set selecting component 26 may limit the number of cheap neighbor cells, for example, to one or two cheap neighbor cells. The monitoring set selecting component 26 may then select the one or two strongest cheap neighbor cells. The monitoring set selecting component 26 may also select at least one strong expensive neighbor cell. The monitoring set selecting component 26 may then fill the monitoring set with old neighbor cells if possible. The foregoing monitoring states are examples. Additional monitoring states may place importance on different types of cells based on a status of the UE or the state of the neighbor list.

The idle mode controller 28 may include hardware, firmware, and/or a processor executing software configured to control cell monitoring during an idle mode. In an aspect, the idle mode controller 28 may be configured to periodically wake up the UE 12 for monitoring during a monitoring cycle while in an idle mode. For example, the idle mode controller 28 may be configured with a sleep cycle index (SCI) indicating how often the UE 12 should wake up to monitor signals from cells. The SCI may be, in an aspect, approximately 5 to 6 seconds. Accordingly, a monitoring cycle may occur approximately every 5 to 6 seconds. In an aspect, for example, in a 1×CDMA system, the idle mode controller 28 may be configured to determine an idle mode state. The idle mode controller 28 may select between an IS2000 state, a quick paging channel (QPCH) online state, and a QPCH offline state. In an aspect, the idle mode controller 28 may be configured to use the QPCH offline state in order to conserve resources. In the QPCH offline state, the UE 12 may turn on the receiver periodically to perform a pilot search on the monitoring set, but may avoid receiving additional information and/or transmitting. In the QPCH online state, the UE 12 may turn on the receiver for receiving some overhead information and may transmit. In an aspect, the idle mode controller 28 may place the UE 12 in QPCH online state when a cell change to an expensive neighbor cells is necessary. The QPCH online state may allow a serving cell change to an expensive neighbor cell. The idle mode controller 28 may leave the UE 12 in QPCH offline state for a cell change to a cheap neighbor cell.

The receiver 30 may be a radio receiver configured to receive radio signals. The receiver 30 may further include additional components of a receive chain for separating and decoding radio signals. For example, in a WCDMA system, the receiver 30 may be configured to separate signals using different PNs or PSCs. The receiver 30 may also be configured to perform a pilot search. The receiver 30 may perform a pilot search by obtaining samples of one or more pilot signals transmitted by one or more cells. The receiver 30 may determine a signal strength of each pilot signal. In an aspect, the receiver 30 may be configured by the cell monitoring component 20 with a monitoring set of cells to monitor. The UE 12 may be configured to power down the receiver 30 when it is not in use. In an aspect, the UE 12 may also include a transmitter (not shown). In an aspect, the receiver 30 and the transceiver may be integrated in a single transceiver.

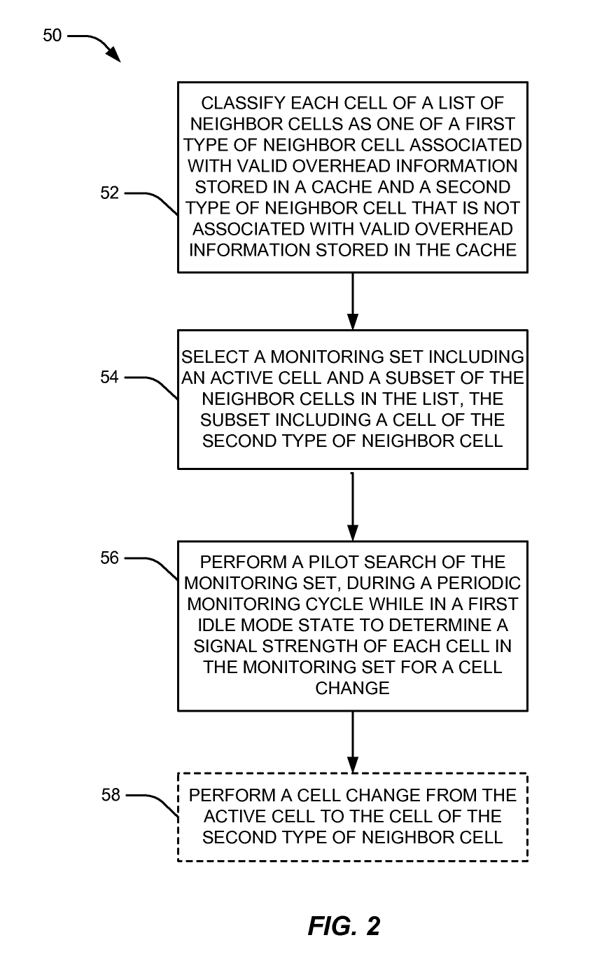

FIG. 2 is a flowchart illustrating a method 50 of monitoring cells in a neighbor cell list during an idle mode. Referring to FIG. 1, in an operational aspect, a UE 12 may perform various aspects of a method 50 for monitoring cells in a neighbor cell list. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, the method 50 may be performed while the UE 12 is operating in an idle mode. For example, the method 50 may be performed while the UE 12 is in a QPCH offline state. The method 50 may be performed when the UE 12 wakes up for a periodic monitoring cycle.

In an aspect, the method 50 includes, at block 52, classifying each cell of a list of neighbor cells as one of a first type of neighbor cell associated with valid overhead information stored in a cache and a second type of neighbor cell that is not associated with valid overhead information stored in the cache. The neighbor cell classifier 24 may classify each cell of the list of neighbor cells as one of the first type of neighbor cell associated with valid overhead information stored in a cache and a second type of neighbor cell that is not associated with valid overhead information stored in the cache. The neighbor cell classifier 24 may look up a neighbor cell according to the cell identifier included in the neighbor cell list. If the cell identifier is not present in the cell cache 22, the cell identifier may be associated with an expensive neighbor cell and the corresponding cell may be classified as an expensive neighbor cell. If the cell identifier is present, but the status of the stored information is invalid or expired, the cell identifier may also be classified as an expensive neighbor cell and additionally may be classified as an old neighbor cell. If the cell identifier is present and the stored information is valid, the cell identifier may be classified as a cheap neighbor cell. Additionally, block 52 may include classifying each cell of the neighbor cell list as strong or weak based on a received signal strength. In an aspect, for example, the neighbor cell classifier 24 may classify a neighbor cell as strong when the most recently measured signal strength of a pilot signal transmitted by the neighbor cell exceeds a threshold value. The classification of a neighbor cell as strong may also be based on a relative comparison of the signal strength of the neighbor cell to the signal strength of the serving cell or to the signal strength of another neighbor cell.

At block 54, the method 50 may include selecting a monitoring set including an active cell and a subset of the neighbor cells in the list, the subset including a cell of the second type of neighbor cell. The monitoring set selecting component 26 may select a monitoring set including the active cell and the subset of the neighbor cells including the cell of the second type of neighbor cell. In an aspect, the monitoring set selecting component 24 may select a strongest expensive neighbor as the cell of the second type of neighbor cell. In an aspect, the monitoring set selecting component 24 may select an old neighbor as the cell of the second type of neighbor cell. In an aspect, the monitoring set selecting component 24 may select the neighbor cells of the monitoring set by determining a state of the neighbor cell list based on the classification of the neighbor cells and selecting the neighbor cells based on the state of the neighbor list.

At block 56, the method 50 may include performing a pilot search of the monitoring set, during a periodic monitoring cycle while in a first idle mode state, to determine a signal strength of each cell in the monitoring set for a cell change. The receiver 30 may perform the pilot search of the monitoring set to determine a signal strength of each cell in the monitoring set for a cell change. For example, in a WCDMA system, the PN or PSC of each neighbor cell may be used to identify a pilot signal transmitted by the respective neighbor cell. The receiver 30 may measure the received signal strength of the pilot signal. The received signal strength may be a received signal strength indicator (RSSI). The cell monitoring component 20 may update the cell cache 22 and/or the classifications of the neighbor cells based on the results of the pilot search. For example, the neighbor cell classifier 24 may classify a cell as strong if an RSSI exceeding a threshold is measured.

In block 58, the method 50 may optionally include performing a cell change from the active cell to the cell of the second type of neighbor cell. The cell monitoring component 20 may perform the cell change from the active cell to the cell of the second type of neighbor cell. The cell monitoring component 20 may determine that the cell of the second type of neighbor cell satisfies a cell change criteria. The idle mode controller 28 may switch the UE 12 to a second idle mode state such as QPCH online state in order to perform the cell change to the expensive neighbor. The receiver 30 may monitor a broadcast channel of the expensive neighbor cell in order to obtain overhead information. The overhead information may be stored in the cell cache 22. The expensive neighbor cell may become the active serving cell and the former active serving cell may become a cheap neighbor cell.

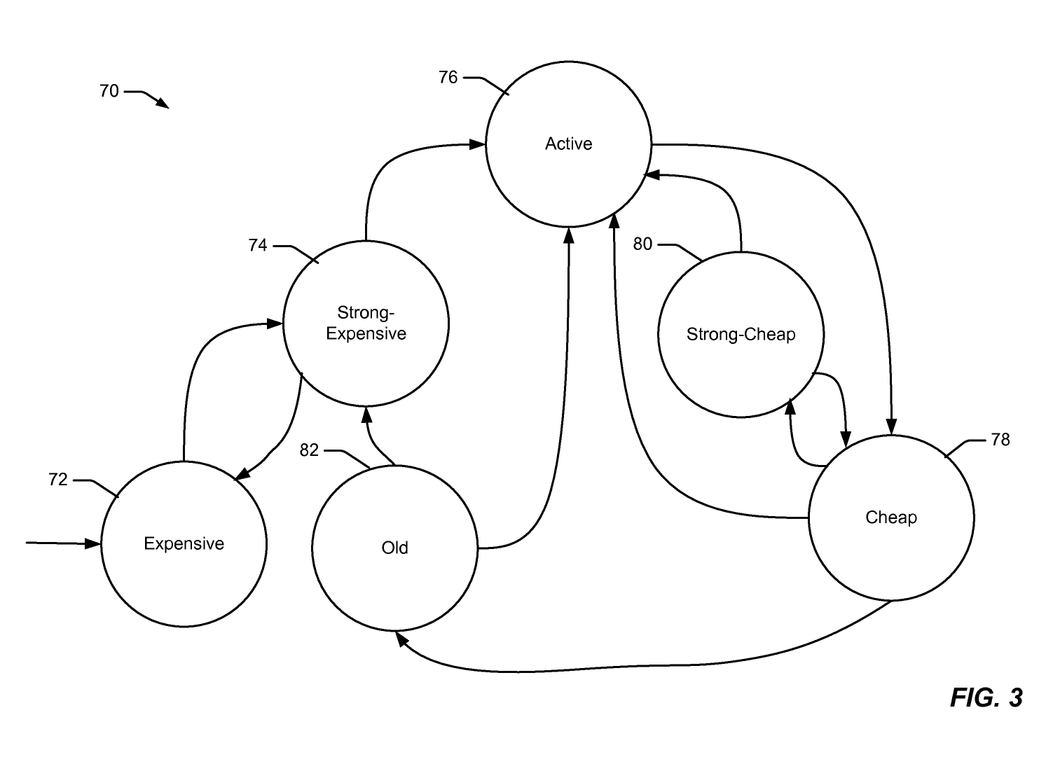

FIG. 3 is a state diagram illustrating classification of neighbor cells. The list of neighbor cells may be provided by an active serving cell. If the UE 12 has no information regarding a cell on the neighbor cell list, the cell may be initially classified in the expensive classification 72. The cell may transition to the strong-expensive classification 74 when a measured signal strength for the cell exceeds a threshold. If a measured signal strength does not exceed the threshold, the cell may remain in an expensive classification 72. A cell in the strong-expensive classification 74 may transition to the active classification 76 through a cell change procedure. In particular, the cell change procedure may be expensive because overhead information for the cell may need to be obtained by receiving a broadcast channel and there are different costs associated with obtaining such information. A cell in the strong-expensive classification 74 may also transition to the expensive classification 72 when a measured signal strength of the cell is less than the threshold. A cell in the active classification 76 may transition to the cheap classification 78 when a cell change procedure replaces the cell as the active serving cell. The overhead information after a cell change will generally remain valid, at least for a period of time. The cell may transition from the cheap classification 78 to the strong-cheap classification 80 based on a measured signal strength and vice-versa. A cell in the cheap classification 78 may also transition to the old classification 82 when overhead information in the cell cache 22 expires and becomes invalid. A cell may transition to the active classification 76 from any of the strong-expensive classification 74, cheap classification 78, strong-cheap classification 80, and old classification 72 based on a cell change procedure that may occur when the cell satisfies the cell change criteria based on the pilot search including measuring the signal strength. In an aspect, a cell may transition from the old classification 82 to the strong-expensive classification 74 when a measured signal strength exceeds a threshold. In an aspect, an active serving cell may change a configuration or access sequence, in which case the UE 12 may obtain overhead information for a plurality of cells, each of which may transition to a cheap classification 78. The classification diagram illustrated in FIG. 3 is provided by way of example and not of limitation.

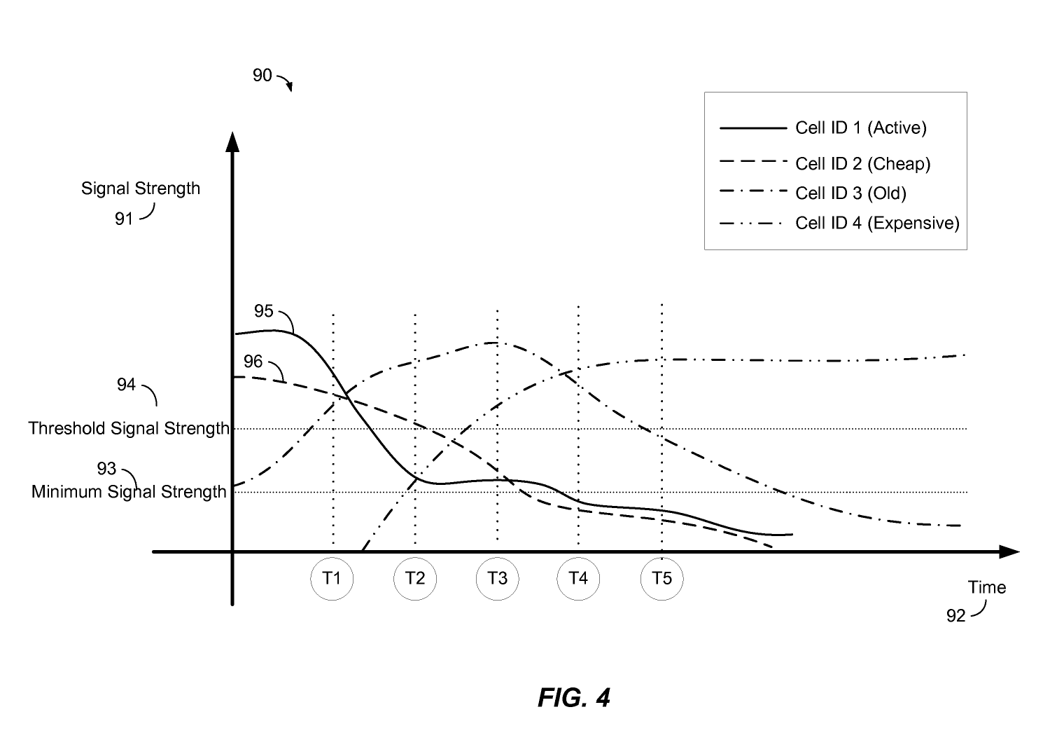

FIG. 4 is a timing diagram 400 illustrating scenario for monitoring neighbor cells during an idle mode. In the timing diagram 90, time 92 may be shown along a horizontal axis and a signal strength 91 may be shown along a vertical axis. The signal strengths for cells 95, 96, 97, 98, which may each correspond to one of cells 14, 16, or 18 (FIG. 1), are shown. Cell 95 may be the active serving cell at T0. The UE 12 may periodically wake up to obtain measurements of one or more cells. For example, the UE 12 may obtain measurements at times T1, T2, T3, T4, and T5.

At time T1, the active cell 95 may be the strongest cell. The UE 12 may also measure cells 95 and/or 96, and determine that no cell change is necessary. The UE 12 may then sleep until time T2. At time T2, the UE 12 may determine a monitoring set. If the UE 12 only selects the active cell and cheap neighbor cells, the UE 12 may only measure cell 95 and 96. The UE may ignore cell 97, which is an old neighbor cell, and cell 98, which is a new expensive neighbor cell. If the UE 12 continues to measure only the active cell and cheap cells, by time T4, the both the cell 95 and 96 may be too weak to support service and the UE 12 may miss a mobile terminated call or may completely lose the network.

In an aspect, the UE 12 may maintain better connectivity to the network by including at least one expensive cell in the monitoring set. For example, at time T2, the UE 12 may include the old cell 97 in the monitoring set. At time T3, the UE may select a different monitoring set, this time including cell 98. Accordingly, at time T3, although it may be cheaper to perform a cell change to cell 96, the UE 12 may perform an expensive cell change to one of the stronger cells 97 or 98 instead. Accordingly, including at least one expensive cell in a monitoring set while operating in an idle mode such as QPCH offline timeline may prevent missed mobile terminated calls or loss of the network. Further, by more often performing cell changes to an expensive neighbor cell, the UE 12 may actually be able to reduce the total number of cell changes necessary and reduce the total amount of time spent awake.

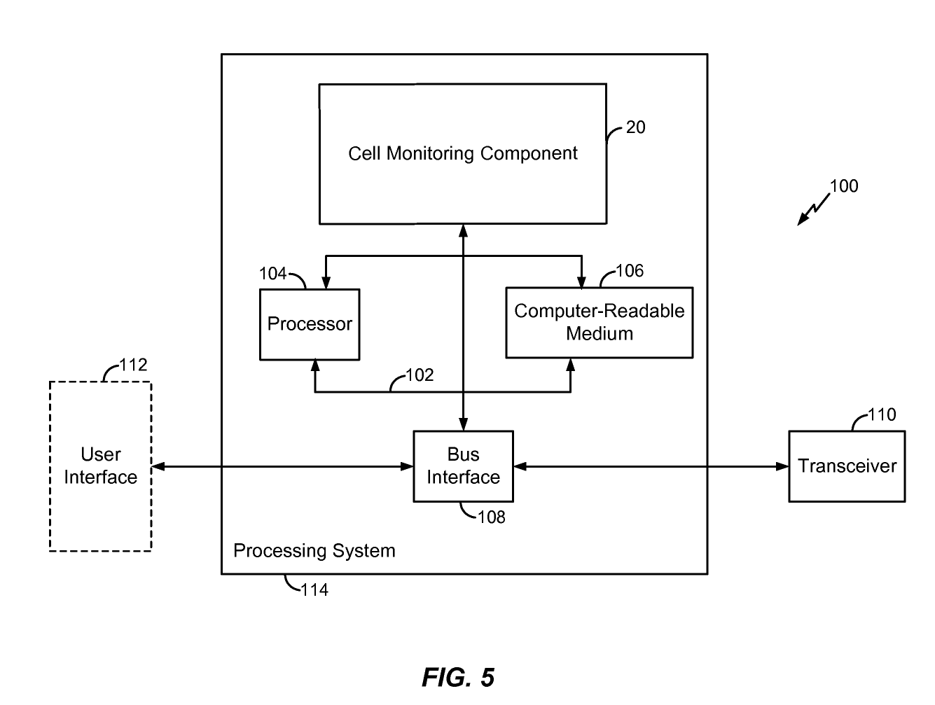

FIG. 5 is a conceptual diagram illustrating an example of a hardware implementation for an apparatus 100 employing a processing system 114. The apparatus 100 may correspond to the UE 12 (FIG. 1) and include a cell monitoring component 20. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 also may link cell monitoring component 20 to processor 104, and computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

In an aspect, at least a portion of the cell monitoring component 20 may be implemented by software executing on processor 104 and operating in conjunction with the computer-readable medium 106 and the bus 102.

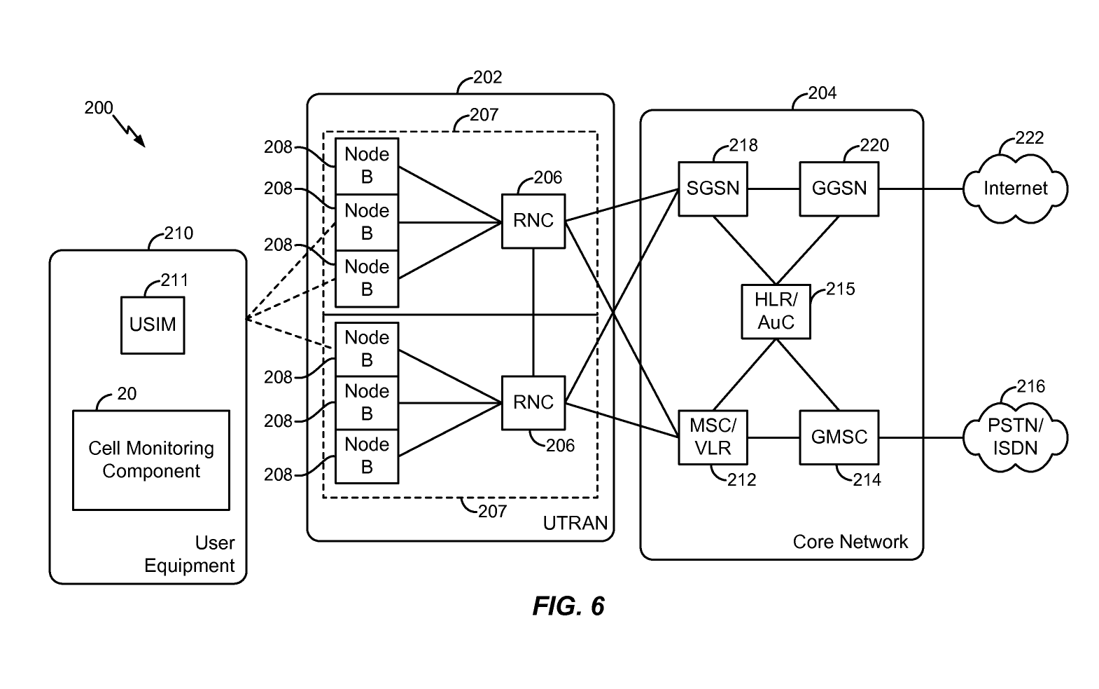

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UEs 210 may each correspond to the UE 12 (FIG. 1) and include a cell monitoring component 20. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information herein utilizes terminology introduced in Radio Resource Control (RRC) Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC) 212, a Visitor location register (VLR) and a Gateway MSC (GMSC) 214. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The core network 204 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

In an aspect, the UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

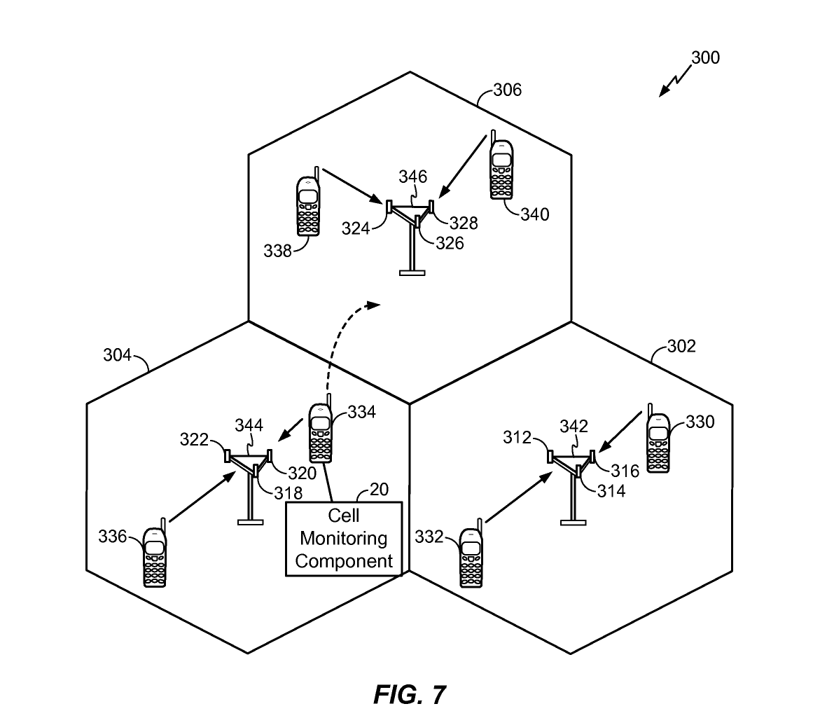

Referring to FIG. 7, an access network 300 in a UTRAN architecture is illustrated. The access network 300 may provide wireless communication access for UEs 330, 332, 334, 336, 338, 340, which may each be an example of the UE 12 in FIG. 1 having a cell monitoring component 20. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a core network 204 (see FIG. 6) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 6), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel (DPCH) or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

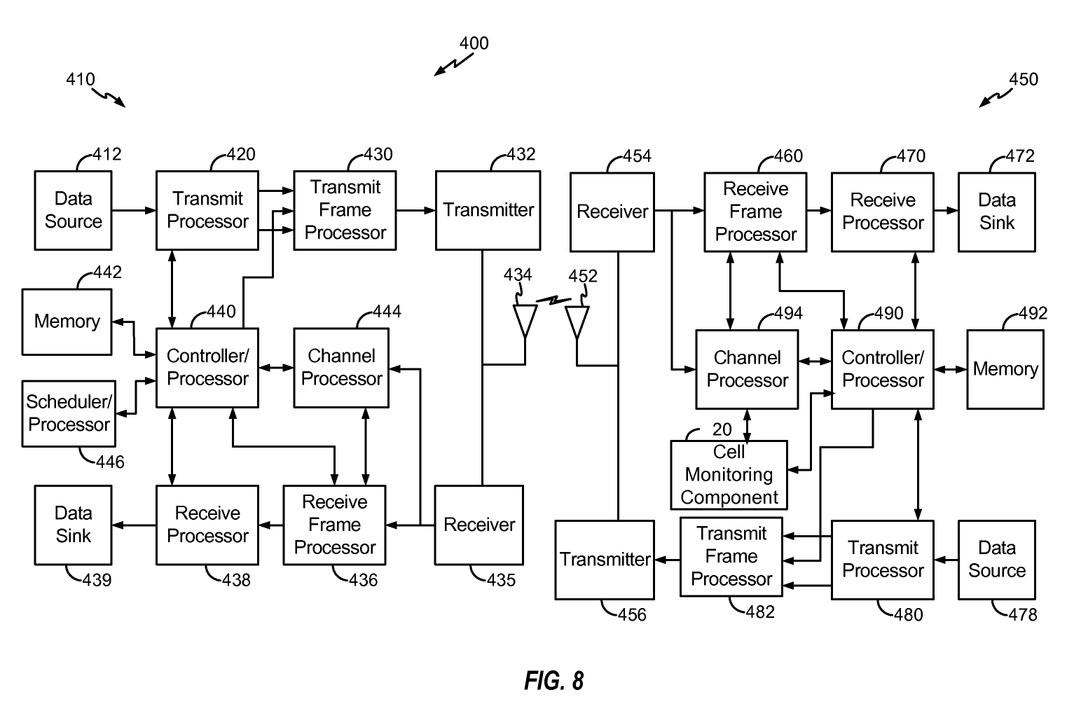

FIG. 8 is a block diagram of a Node B 410 in communication with a UE 450, where the Node B 410 may be the Node B 208 in FIG. 6 or one or the cells 14, 16, 18 in FIG. 1, and the UE 450 may be the UE 210 in FIG. 6 or the UE 12 in FIG. 1 having a cell monitoring component 20. The UE 450 may include a cell monitoring component 20 for monitoring cells while in an idle mode. In the downlink communication, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for downlink transmission over the wireless medium through antenna 434. The antenna 434 may include one or more antennas, for example, including beam steering bidirectional adaptive antenna arrays or other similar beam technologies.

At the UE 450, a receiver 454 receives the downlink transmission through an antenna 452 and processes the transmission to recover the information modulated onto the carrier. The receiver 30 (FIG. 1) may be implemented by the receiver 454 and/or other components of the UE 450 including the antenna 452, receive frame processor 460, and receive processor 470. The information recovered by the receiver 454 is provided to a receive frame processor 460, which parses each frame, and provides information from the frames to a channel processor 494 and the data, control, and reference signals to a receive processor 470. The receive processor 470 then performs the inverse of the processing performed by the transmit processor 420 in the Node B 410. More specifically, the receive processor 470 descrambles and despreads the symbols, and then determines the most likely signal constellation points transmitted by the Node B 410 based on the modulation scheme. These soft decisions may be based on channel estimates computed by the channel processor 494. The soft decisions are then decoded and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded by the receiver processor 470, the controller/processor 490 may also use an acknowledgement (ACK) and/or negative acknowledgement (NACK) protocol to support retransmission requests for those frames. The cell monitoring component 20 may be implemented, for example, by the controller/processor 490 executing software to control other components for example, receiver 454, receive frame processor 460 receive processor 470 and channel processor 494. The software may reside in memory 492.

In the uplink, data from a data source 478 and control signals from the controller/processor 490 are provided to a transmit processor 480. The data source 478 may represent applications running in the UE 450 and various user interfaces (e.g., keyboard). Similar to the functionality described in connection with the downlink transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for uplink transmission over the wireless medium through the antenna 452.

The uplink transmission is processed at the Node B 410 in a manner similar to that described in connection with the receiver function at the UE 450. A receiver 435 receives the uplink transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used to allocate resources to the UEs and schedule downlink and/or uplink transmissions for the UEs.

Several aspects of a telecommunications system have been presented with reference to an HSPA system. As those skilled in the art will readily appreciate, various aspects described throughout this disclosure may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communications for monitoring wireless cells, the method comprising:
classifying each cell of a list of neighbor cells as one of a first type of neighbor cell associated with valid overhead information stored in a cache and a second type of neighbor cell that is not associated with valid overhead information stored in the cache;
selecting a monitoring set including an active cell and a subset of the neighbor cells in the list, the subset including a cell of the second type of neighbor cell; and
performing a pilot search of the monitoring set, during a periodic monitoring cycle while in a first idle mode state, to determine a signal strength of each cell in the monitoring set for a cell change.

2. The method of claim 1, further comprising:
determining that the cell of the second type of neighbor cell satisfies a cell change criteria;
switching to a second idle mode state allowing a cell change to the second type of neighbor cell; and
performing a cell change from the active cell to the cell of the second type of neighbor cell.

3. The method of claim 2, wherein performing a cell change to the cell of the second type of neighbor cell includes:
obtaining overhead information of the cell of the second type of neighbor cell;
storing the overhead information in the cache; and
updating the classification of the cell of the second type of neighbor cell based on a new cache status resulting from the overhead information stored in the cache.

4. The method of claim 1, further comprising updating the classification of each of the cells in the monitoring set based on the respective determined signal strengths.

5. The method of claim 1, wherein classifying each cell of the list of neighbor cells includes determining whether a cell change from the active cell to the respective cell being classified requires reception of overhead information from a broadcast channel based on a status of information stored in the cache regarding the cell.

6. The method of claim 1, wherein selecting the monitoring set includes selecting the active cell, and selecting no more than two cells of the first type of neighbor cell, and at least one cell of the second type of neighbor cell as part of the subset.

7. The method of claim 1, further comprising determining a state of the neighbor list based on the classifying, wherein selecting the monitoring set is based on the state of the neighbor list.

8. The method of claim 7, wherein the state of the neighbor list indicates cells of the first type of neighbor cell are to be included in the monitoring set, and wherein selecting the monitoring set based on the state of the neighbor list includes:
selecting the active cell;
selecting the cell of the second type of neighbor cell as part of the subset, and
selecting cells of the first type of neighbor cell in order of decreasing signal strength as part of the subset until the monitoring set is full.

9. The method of claim 8, wherein classifying each cell of the list of neighbor cells includes classifying a cell of the second type of neighbor cell as a third type of cell associated with an expired cache status, wherein the monitoring set includes a cell of the third type of cell.

10. The method of claim 9, wherein the state of the neighbor list indicates that cells of the second type of neighbor cell are to be included in the monitoring set, and wherein selecting the monitoring set based on the state of the neighbor list includes:
selecting the active cell;
selecting no more than two cells of the first type of neighbor cell as part of the subset;
selecting a cell of the third type of neighbor cell as part of the subset; and
selecting cells of the second type of neighbor cells in order of decreasing signal strength as part of the subset until the monitoring set is full.

11. The method of claim 9, wherein the state of the neighbor list indicates that cells of the third type of neighbor cell are to be included in the monitoring set, and wherein selecting the monitoring set based on the state of the neighbor list includes:
selecting the active cell;
selecting no more than two cells of the first type of neighbor cell as part of the subset;
selecting the cell of the second type of neighbor cell as part of the subset; and
selecting cells of the third type of neighbor cell as part of the subset until the monitoring set is full.

12. The method of claim 1, wherein classifying each cell of a list of neighbor cells includes classifying a second cell of the second type of neighbor cell as a fourth type of neighbor cell having a signal strength greater than a threshold and based on a measurement of a pilot signal corresponding to the second cell of the second neighbor type, wherein the monitoring set includes the cell of the fourth type of cell.

13. An apparatus for monitoring wireless cells, comprising:
a cell cache configured to store overhead information associated with neighbor cells;
a neighbor cell classifier configured to classify each cell of a list of neighbor cells as one of a first type of neighbor cell associated with valid overhead information stored in the cache and a second type of neighbor cell that is not associated with valid overhead information stored in the cache;
a monitoring set selecting component configured to select a monitoring set including an active cell and a subset of the neighbor cells in the list, the subset including a cell of the second type of neighbor cell; and
a receiver configured to perform a pilot search of the monitoring set, during a periodic monitoring cycle while in a first idle mode state, to determine a signal strength of each cell in the monitoring set for a cell change.

14. The apparatus of claim 13, further comprising an idle mode controller configured to:
determine that the cell of the second type of neighbor cell satisfies a cell change criteria;
switch to a second idle mode state allowing a cell change to the second type of neighbor cell; and
perform a cell change from the active cell to the cell of the second type of neighbor cell.

15. The apparatus of claim 14, wherein the receiver is further configured to obtain cell overhead information of the cell of the second type of neighbor cell and store the cell overhead information in the cell cache; and the neighbor cell classifier is further configured to update the classification of the cell of the second type of neighbor cell based on a new cache status resulting from the cell overhead information stored in the cell cache.

16. The apparatus of claim 13, wherein the monitoring set selecting component is configured to select the monitoring set by selecting the active cell, and selecting no more than two cells of the first type of neighbor cell, and at least one cell of the second type of neighbor cell as part of the subset.

17. The apparatus of claim 13, wherein the monitoring set selecting component is further configured to determine a state of the neighbor list based on the classifying, wherein selecting the monitoring set is based on the state of the neighbor list.

18. The apparatus of claim 14, wherein the cell classifier is further configured to determine whether a cell change from the active cell to the respective cell requires reception of overhead information from a broadcast channel based on a status of information stored in the cell cache regarding the cell.

19. An apparatus for monitoring wireless cells, the apparatus comprising:
means for classifying each cell of a list of neighbor cells as one of a first type of neighbor cell associated with valid overhead information stored in a cache and a second type of neighbor cell that is not associated with valid overhead information stored in the cache;
means for selecting a monitoring set including an active cell and a subset of the neighbor cells in the list, the subset including a cell of the second type of neighbor cell; and
means for performing a pilot search of the monitoring set, during a periodic monitoring cycle while in a first idle mode state, to determine a signal strength of each cell in the monitoring set for a cell change.

20. The apparatus of claim 19, further comprising:
means for determining that the cell of the second type of neighbor cell satisfies a cell change criteria;
means for switching to a second idle mode state allowing a cell change to the second type of neighbor cell; and
means for performing a cell change from the active cell to the cell of the second type of neighbor cell.

21. The apparatus of claim 20, further comprising:
means for obtaining cell overhead information of the cell of the second type of neighbor cell;
means for storing the cell overhead information in the cache; and
means for updating the classification of the cell of the second type of neighbor cell based on a new cache status resulting from the cell overhead information stored in the cache.

22. The apparatus of claim 19, wherein the means for selecting the monitoring set are configured to select the active cell, and select no more than two cells of the first type of neighbor cell, and at least one cell of the second type of neighbor cell as part of the subset.

23. The apparatus of claim 19, further comprising means for determining a state of the neighbor list based on the classifying, wherein the means for selecting the monitoring set is configured to select the monitoring set based on the state of the neighbor list.

24. The apparatus of claim 19, wherein the means for classifying is configured to determine whether a cell change from the active cell to the respective cell requires reception of overhead information from a broadcast channel based on a status of information stored in the cache regarding the cell.

25. A computer-readable medium storing computer executable code for monitoring wireless cells the computer-readable medium comprising code for:
classifying each cell of a list of neighbor cells as one of a first type of neighbor cell associated with valid overhead information stored in a cache and a second type of neighbor cell that is not associated with valid overhead information stored in the cache;
selecting a monitoring set including an active cell and a subset of the neighbor cells in the list, the subset including a cell of the second type of neighbor cell; and
performing a pilot search of the monitoring set, during a periodic monitoring cycle while in a first idle mode state, to determine a signal strength of each cell in the monitoring set for a cell change.

26. The computer-readable medium of claim 25, further comprising code for:
determining that the cell of the second type of neighbor cell satisfies a cell change criteria;
switching to a second idle mode state allowing a cell change to the second type of neighbor cell; and
performing a cell change from the active cell to the cell of the second type of neighbor cell.

27. The computer-readable medium of claim 26, wherein the code for performing a cell change to the cell of the second type of neighbor cell includes code for:
obtaining cell overhead information of the cell of the second type of neighbor cell;
storing the cell overhead information in the cache; and
updating the classification of the cell of the second type of neighbor cell based on a new cache status resulting from the cell overhead information stored in the cache.

28. The computer-readable medium of claim 25, wherein the code for selecting the monitoring set includes code for selecting the active cell, and code for selecting no more than two cells of the first type of neighbor cell, and at least one cell of the second type of neighbor cell as part of the subset.

29. The computer-readable medium of claim 25, further comprising code for determining a state of the neighbor list based on the classifying, wherein selecting the monitoring set is based on the state of the neighbor list.

30. The computer-readable medium of claim 25, wherein the code for classifying each cell of a list of neighbor cells includes code for determining whether a cell change from the active cell to the respective cell requires reception of overhead information from a broadcast channel based on a status of information stored in the cache regarding the cell.
